(19) United States
(12) Patent Application Publication
(10) Pub. No.: US 2009/0266571 A1
(43) Pub. Date: Oct. 29, 2009

(54) HAND-GUIDED POWER TOOL WITH A POWER TRAIN AND A DECOUPLING DEVICE

(76) Inventors: Otto Baumann, Leinfelden-Echterdingen (DE); Thomas Bernhardt, Aichtal-Groetzingen (DE); Hardy Schmid, Stuttgart (DE); Juergen Lennartz, Ostfildern (DE)

Correspondence Address: MICHAEL J. STRIKER, 103 EAST NECK ROAD, HUNTINGTON, NY, 11743, US

(21) Appl. No.: 11/914,801

(22) PCT Filed: Nov. 7, 2006
(86) PCT No.: PCT/EP2006/068165

§ 371 Date: Nov. 19, 2007

(30) Foreign Application Priority Data
Dec. 12, 2005 (DE) 10 2005 059 180.9

(51) Int. Cl. B25D 17/24; B25F 5/02

(52) U.S. Cl. 173/162.2

(57) ABSTRACT

The invention relates to a manual machine tool having a drivetrain (12a; 12b) and at least one decoupling unit (20a; 20b). The invention is characterized in that the decoupling unit (20a; 20b) is arranged between two drivetrain units (12a; 12b; 16a; 16b).

### PRIOR ART

The invention is based on a hand-guided power tool with a power train and a decoupling device as recited in the preamble to claim 1.

There are already known hand-guided power tools, in particular rotary hammers, which are equipped with a decoupling device for reducing a transmission of vibration. In this instance, only handle zones or parts of the housing are insulated in relation to a vibration source such as an impact mechanism. As a rule, these hand-guided power tools are equipped with a power train that includes a transmission unit and a motor unit.

### ADVANTAGES OF THE INVENTION

The invention is based on a hand-guided power tool with a power train and at least one decoupling device.

Preferably, the decoupling device is situated between two power train units. The expression “decoupling device” should be understood in particular to mean a damping unit and/or a vibration insulating unit. In addition, the term “between” should be understood in particular to mean a placement that is between the power train units spatially and/or in a flux of force continuum. This makes it possible to achieve a decoupling of large masses, in particular a vibration decoupling between two masses. It is thus possible to reduce the vibration of the hand-guided power tool and to reduce a transmission of vibrations to a user of the hand-guided power tool.

The decoupling device is advantageously situated between a drive unit and a transmission unit of the power train. It is thus possible to achieve a reduction in the vibrations in one of the two drive units. In addition, this decoupling device can achieve a longer service life of the electrical components in the vibration-reduced drive unit of the hand-guided power tool.

In another embodiment of the invention, a housing unit of the drive unit has a coupling point for the attachment of an auxiliary handle. The expression “coupling point” should be understood in this context to mean in particular an especially embodied, equipped, and/or provided location for the attachment of an auxiliary handle, which location preferably has special fastening means such as recesses, protrusions, etc. This can be advantageously achieved by elongating the housing unit of the drive unit in an advantageous direction. The advantage of this is that the auxiliary handle can be attached to the vibration-insulated drive unit. It is thus possible to vibration-decouple both points at which the user comes into contact with the hand-guided power tool.

In another embodiment, the decoupling device has at least two degrees of freedom in its decoupling action, which makes it possible to achieve a compensation movement in several directions between the power train units and to achieve an accompanying reduction in a vibration transmission in several directions.

The decoupling unit advantageously has at least one decoupling means that is provided to produce a decoupling by means of a deformation, preferably by means of an elastic deformation, thus making it possible to avoid an occurrence of wear in the decoupling device due to external friction.

It is also advantageous if the decoupling device has a bellows-shaped decoupling means, which makes it possible to achieve a wear-free decoupling, even in the case of high-frequency relative movements, and to achieve an advantageous deformation path. The expression “bellows-shaped” decoupling means should be understood to mean in particular a decoupling means that is thin-walled in relation to the span of its area and is folded at least in some regions.

In another embodiment, the decoupling means has a radial orientation in at least one region. The expression “radial orientation” should be understood in this context to mean in particular that at least one outer surface and/or one inner surface of the decoupling means, in particular a wall of the decoupling means, has at least one radial component in its orientation. Through a corresponding embodiment, a construction can be achieved that is particularly space-saving in the axial direction.

The decoupling device is advantageously embodied as at least in part integrally joined to an additional functional means, thus making it possible achieve savings with regard to parts, space, weight, assembly complexity, and costs. The expression “additional functional means” should be understood to signify in particular all means deemed appropriate by those skilled in the art, said means, in addition to a decoupling and/or a force transmission, in particular having an additional function, in particular functional means that rotates along with the decoupling device. An advantageous example of this is a fan unit.

In another embodiment of the invention, the hand-guided power tool has a guide unit, which includes at least one spring-loaded guide means and is provided for guiding at least one of the power train units. In addition to an advantageous decoupling, this makes it possible to achieve a hand-guided power tool that is intrinsically stable.

If the guide unit has at least one decoupling means for supporting a guide element, it is possible to at least reduce undesirable transmissions of vibration via the guide unit.

The embodiment according to the invention can be used in all hand-guided power tools deemed appropriate by those skilled in the art, but can be used to particular advantage in hand-guided power tools equipped with hammering power train units, in particular rotary hammers and chisel hammers, etc.

### DRAWINGS

Other advantages ensue from the following description of the drawings. The drawings depict exemplary embodiments of the invention. The drawings, the description, and the claims contain numerous features in combination. Those skilled in the art will also suitably consider the features individually and unite them to form other meaningful combinations.

FIG. 1 is a partial section through a hand-guided power tool with a schematically depicted bellows-shaped decoupling device that is situated between a drive unit and a transmission unit,

FIG. 2 is a side view of the hand-guided power tool from FIG. 1,

FIG. 3 is a cross section through the hand-guided power tool shown in FIG. 2, in the region of a guide unit,

FIG. 4 is an elastomer-supported guide element of the guide unit from FIG. 3,

FIG. 5 is a cross section through the hand-guided power tool shown in FIG. 2, in the region of an alternative guide unit, and

FIG. 6 shows a detail of a hand-guided power tool with an alternative bellows-shaped decoupling device.

### DESCRIPTION OF THE EXEMPLARY EMBODIMENTS

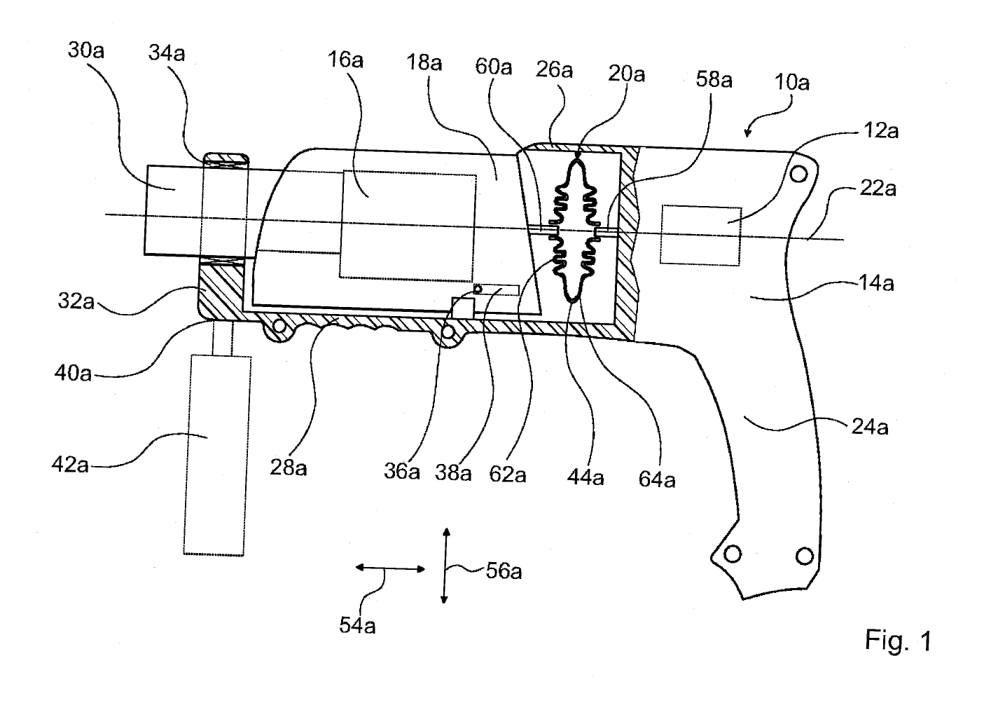

FIG. 1 shows a side view of a hand-guided power tool 10a embodied in the form of a rotary hammer. It includes a drive unit 12a, which has its own housing unit 14a embodied in the form of a drive housing, a transmission unit 16a, which has its own housing unit 18a embodied in the form of a transmission housing, and a bellows-shaped decoupling device 20a, which is situated between the drive unit 12a and the transmission unit 16a. The transmission unit 16a contains an impact mechanism, which is indicated in the drawing.

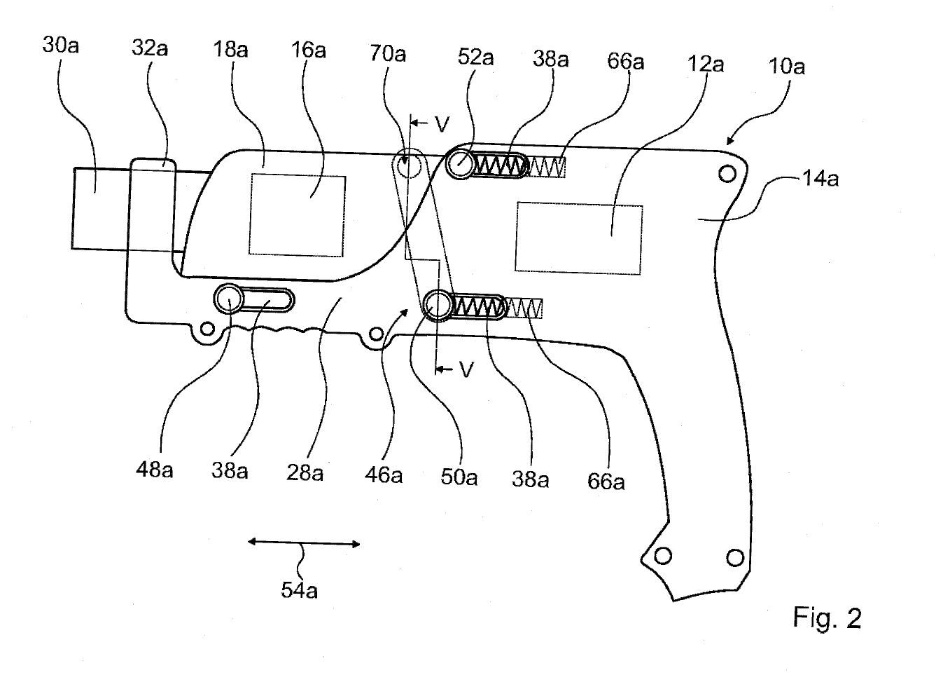

The housing unit 14a embodied in the form of the drive housing has a main handle 24a integrally joined to it, which extends essentially perpendicular to a longitudinal axis 22a of the hand-guided power tool 10a and has an actuating switch. In the direction toward a front end of the hand-guided power tool 10a, the housing unit 14a embodied in the form of the drive housing has a receptacle region 26a for the decoupling device 20a and a shell-shaped receiving region 28a for the housing unit 18a embodied in the form of the transmission housing (FIGS. 1 and 2). In the direction toward a tool socket region 30a of the hand-guided power tool 10a, the shell-shaped receiving region 28a adjoins a sleeve-shaped receiving region 32a in which the transmission unit 16a is supported by means of a plain bearing bush 34a. In order to achieve as vibration-decoupled as possible a support of the transmission unit 16a in the sleeve-shaped receiving region 32a of the housing unit 14a embodied in the form of the drive housing, the plain bearing bush 34a is encompassed by a bushing element composed of oscillation-damping rubber material. In addition, the housing unit 18a embodied in the form of the transmission housing is guided by means of a plurality of plain bearing bushes 36a that are guided in slots 38a of the shell-shaped receiving region 28a of the housing unit 14a and are secured in a stable, vibration-damped position in relation to the housing unit 14a.

The sleeve-shaped region of the housing unit 14a embodied in the form of the drive housing includes a coupling point 40a for an auxiliary handle 42a.

The decoupling device 20a includes a decoupling means 44a embodied in the form of a bellows coupling composed of an elastic plastic, which enables a vibration decoupling between the transmission unit 16a and the drive unit 12a in both the axial direction 54a and the radial direction 56a. Alternatively to an elastic plastic, it is conceivable for the decoupling device 20a to be made of other materials deemed appropriate by those skilled in the art, e.g. rubber materials, metal compounds, etc.

The decoupling means 44a has two disk-shaped, thin-walled subregions 62a, 64a arranged in mirror image fashion in relation to each other; a subregion 62a is oriented toward the drive unit 12a and an opposite subregion 64a is oriented toward the transmission unit 16a. Instead of being arranged in mirror image fashion, however, the subregions can also be embodied differently and adapted to various requirements. The walls of the two subregions 62a, 64a of the decoupling means 44a are also provided with a folded structure, which lends the decoupling means 44a a very pronounced vibration-damping property. The folded structure of the subregions 62a, 64a compensates for even large relative movements of the transmission unit 16a in relation to the drive unit 12a, thus assuring a virtually wear-free vibration decoupling in the axial direction 54a and in the radial direction 56a.

During operation, a drive torque of the drive unit 12a is conveyed via the decoupling unit 20a to the transmission unit 16a, in fact with a vibration decoupling that occurs in parallel fashion between the transmission unit 16a and the drive unit 12a. A drive shaft 58a of the drive unit 12a here is inserted into a recess, which is situated coaxial to the drive shaft 58a in the subregion 62a oriented toward the drive unit 12a, and is connected to the subregion 62a of the decoupling device 20a by means of a form-locked engagement in the circumference direction, which is not shown in detail.

The subregion 64a oriented toward the transmission unit 16a likewise has a recess, which is situated coaxial to the drive shaft 58a and into which a transmission shaft 60a of the transmission unit 16a is inserted. Like the drive shaft 58a, the transmission shaft 60 is connected to the subregion 64a of the decoupling device 20a by means of a form-locked engagement in the circumference direction, which is not shown in detail. The transmission shaft 60a relays the torque to the transmission unit 16a.

FIG. 2 shows a side view of the hand-guided power tool 10a from FIG. 1, with a guide unit 46a of the housing unit 14a embodied in the form of the drive housing, by means of which guide unit 46a, the housing unit 18a embodied in the form of the transmission housing is guided inside the housing unit 14a. The housing unit 18a is guided by being attached to the housing unit 14a embodied in the form of the drive housing on both sides by means of three guide elements 48a, 50a, 52a embodied in the form of shoulder bolts 68a (FIGS. 2 and 4)

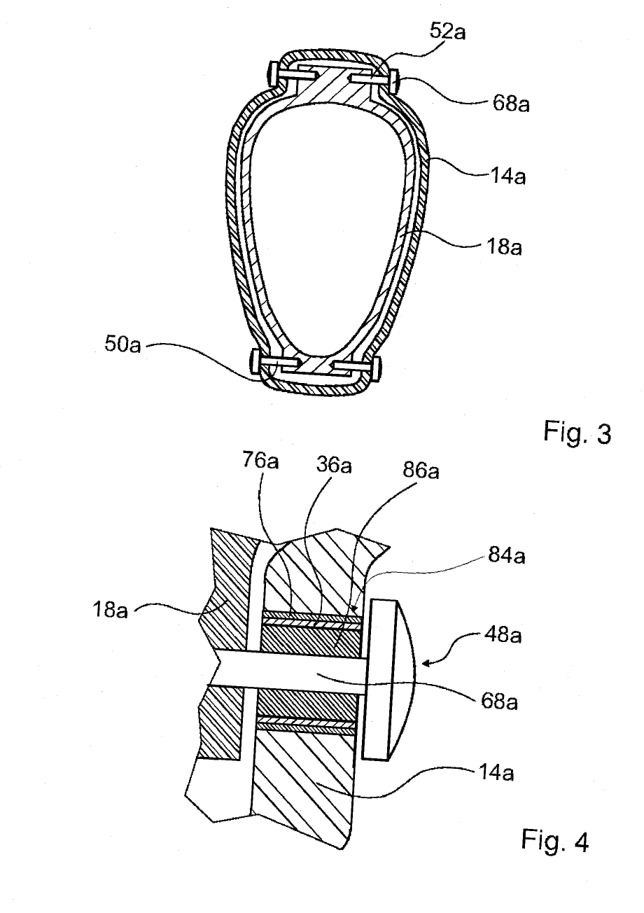

The guide elements 48a, 50a, 52a in this case are permanently attached to the housing unit 18a embodied in the form of the transmission housing and are situated so that they can move in the axial direction 54a in slots 38a of the housing unit 14a and are secured in the slots 38a by bolt heads of the guide elements 48a, 50a, 52a embodied in the form of shoulder bolts 68a (FIGS. 2 and 3). The guidance of the guide elements 48a, 50a, 52a in the slots 38a permits a relative movement of the housing unit 18a embodied in the form of the transmission housing in relation to the housing unit 14a, which, in cooperation with the decoupling device 20a, can occur in a vibration-decoupled fashion in relation to the housing unit 14a. In addition, guide means 66a embodied in the form of prestressed spring units are attached on both sides in the axial direction 54a between the guide elements 48a and 50a and the housing unit 14a embodied in the form of the drive housing. When the hand-guided power tool 10a is at rest, the guide means 66a keep the housing unit 18a embodied in the form of the transmission housing in a stable starting position in relation to the housing unit 14a. When the housing unit 18a embodied in the form of the transmission housing executes relative movements in relation to the housing unit 14a, once it leaves the starting position, spring forces of the guide means 66a counteract the movement until the housing unit 18a once again assumes a stable position. These guide means 66a thus enable a stable guidance of the hand-guided power tool 10a and, in addition to the decoupling device 20a, exert a vibration-damping action on the housing unit 14a embodied in the form of the drive housing.

In the vibration-damped guidance between the housing unit 14a embodied in the form of the drive housing and the housing unit 18a embodied in the form of the transmission housing, the cross-sectionally egg-shaped housing unit 14a encompassing the housing unit 18a is spaced apart from the housing unit 18 a embodied in the form of the transmission housing (FIGS. 3 and 4). Bushing elements 84a guide the guide elements 48a, 50a, 52a in plain bearing bushes 76a made of metal, which are inserted into the slots 38a and are respectively adapted to the shape of the slots 38a. The cylindrically embodied bushing elements 84a have a decoupling means of 86a embodied in the form of a rubber bushing and a plain bearing bush 36a made of metal that encompasses the decoupling means 86a. The plain bearing bushes 36a achieve a low degree of friction during operation and the decoupling means 86a achieves an advantageous decoupling in a plurality of directions during operation.

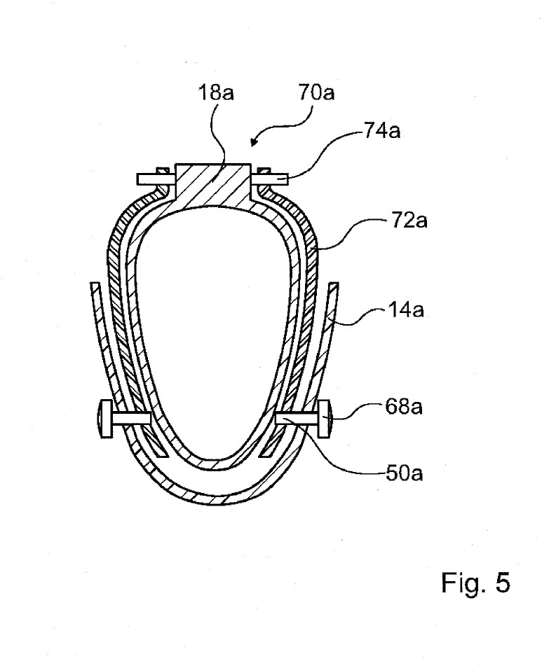

As an alternative to this, a guide unit 46a with the guide elements 48a and 50a and a cross-linking unit 70a can be provided (FIGS. 2 and 5). The cross-linking unit 70a is composed of two laterally situated cross-linking brackets 72a, which are coupled to the housing unit 14a embodied in the form of the drive housing by means of guide elements 50a attached on both sides. The cross-linking brackets 72a are oriented perpendicular to the longitudinal axis 22a, between the housing unit 14a embodied in the form of the drive housing and the housing unit 18a embodied in the form of the transmission housing. A rubber-supported axle 74a oriented perpendicular to the longitudinal axis 22a and essentially perpendicular to the main handle 24a produces a connection of the cross-linking bracket 72a to the housing unit 18a embodied in the form of the transmission housing. The cross-linking unit 70a can achieve a guidance of the transmission unit 16a in the housing unit 14a embodied as the drive housing and can also assure a vibration decoupling between the transmission unit 16a and the drive unit 12a. The guide elements 48a, 50a in the guide unit 46a are likewise supported on the housing unit 14a embodied in the form of the drive housing by means of the prestressed spring units 66a.

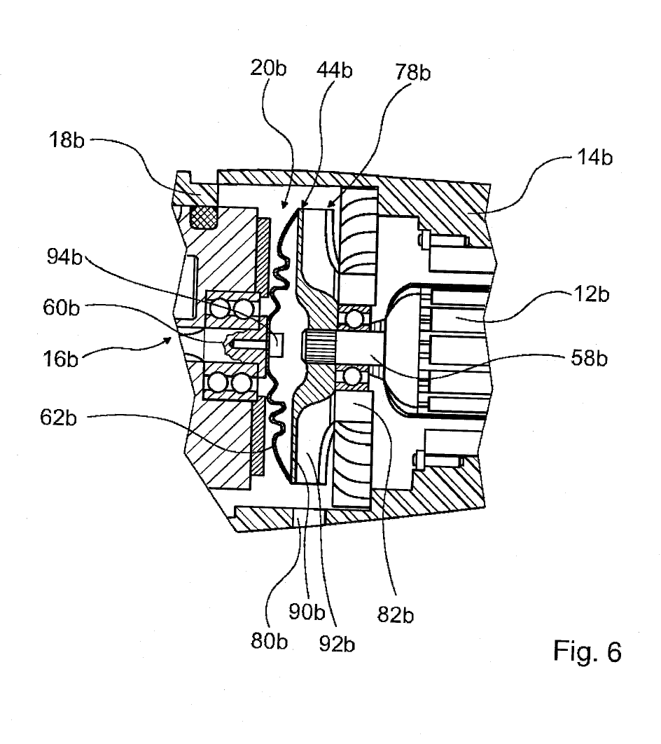

FIG. 6 shows an alternative bellows-shaped decoupling device of a hand-guided power tool. Parts that essentially correspond to one another have been provided with essentially the same reference numerals; in order to differentiate between the exemplary embodiments, the letter a (FIGS. 1 through 5) or b (FIG. 6) is added to the reference numerals. In addition, for features and functions that remain the same, reference can be made to the description of the exemplary embodiment in FIG. 1. The following description of FIG. 6 is essentially limited to the differences from the exemplary embodiment in FIGS. 1 through 5.

The decoupling device 20b has only one disk-shaped subregion 62b that is spring-elastic in both the radial direction 56b and axial direction 54b; it is situated on the side of the decoupling device 20b oriented toward a transmission unit 16b. By means of a multi-component, in particular a two-component, method, the decoupling device 20b is integrally formed onto a functional means that includes a fan unit 78b. On its side oriented toward the subregion 62b, the fan unit 78b has an annular disk 90b whose outer edge region is attached to the spring-elastic subregion 62b of the decoupling device 20b and whose side oriented toward the drive unit 12b has fan blades 92b integrally formed onto it, which are provided for cooling the drive unit 12b. Ventilation openings 80b let into a housing wall of the housing unit 14b embodied in the form of the drive housing provide an air supply for the fan unit 78b. Ventilation conduits 82b convey an airflow to the drive unit 12b.

The fan unit 78b is coupled to a drive shaft 58b in a way that prevents the two from rotating in relation to each other while the spring-elastic subregion 62b of the decoupling device 20b is attached to a transmission shaft 60b in a way that prevents the two from rotating in relation to each other. In this instance, the spring-elastic subregion 62b is pressed against an end surface of the transmission shaft 60b by a screw 94b and is attached to the transmission shaft 60b in a form-locked fashion in the circumference direction by means of form-locking elements that are not shown in detail.

What is claimed is:

1. A hand-guided power tool that has a power train and at least one decoupling device (20a; 20b),
wherein the decoupling device (20a; 20b) is situated between two power train units (12a; 12b; 16a; 16b).

2. The hand-guided power tool as recited in claim 1,
wherein the decoupling device (20a; 20b) is situated between a drive unit (12a; 12b) and a transmission unit (16a; 16b) of the power train.

3. The hand-guided power tool as recited in claim 2,
wherein a housing unit (14a; 14b) of the drive unit (12a; 12b) has a coupling point (40a) for the attachment of an auxiliary handle (42a).

4. The hand-guided power tool as recited in claim 1,
wherein the decoupling device (20a; 20b) has at least two degrees of freedom in its decoupling action.

5. The hand-guided power tool as recited in claim 1,
wherein the decoupling device (20a; 20b) has at least one decoupling means (44a) that is provided to achieve a decoupling by means of a deformation.

6. The hand-guided power tool as recited in claim 5,
wherein the decoupling device (20a; 20b) has a bellows-shaped decoupling means (44a).

7. The hand-guided power tool as recited in claim 5,
wherein the decoupling means (44a) has a radial orientation (56a) in at least one region.

8. The hand-guided power tool as recited in claim 1,
wherein at least part of the decoupling device (20a; 20b) is embodied as integrally joined to another functional means.

9. The hand-guided power tool as recited in claim 8,
wherein at least part of the decoupling device (20a; 20b) is embodied as integrally joined to a fan unit (78b).

10. The hand-guided power tool as recited in claim 1,
characterized by means of a guide unit (46a), which includes at least one spring-loaded guide means (66a) and is provided to guide at least one of the power train units (12a; 12b; 16a; 16b).

11. The hand-guided power tool as recited in claim 10,
wherein the guide unit (46a) has at least one decoupling means (86a) for supporting a guide element (48a, 50a, 52a).
